(19) United States
(12) Patent Application Publication
(10) Pub. No.: US 2022/0408864 A1
(43) Pub. Date: Dec. 29, 2022

(54) FABRIC AND PROTECTIVE PRODUCT

(71) Applicant: TEIJIN LIMITED, Osaka-shi, Osaka (JP)

(72) Inventor: Kengo TANAKA, Osaka (JP)

(73) Assignee: TEIJIN LIMITED, Osaka-shi, Osaka (JP)

(21) Appl. No.: 17/771,998

(22) PCT Filed: Oct. 20, 2020
(86) PCT No.: PCT/JP2020/039309

§ 371 Date: Apr. 26, 2022

(30) Foreign Application Priority Data
Nov. 18, 2019 (JP) 2019-208003
Nov. 27, 2019 (JP) 2019-214056

(51) Int. Cl. A41D 31/08; D03D 15/283; D03D 15/513; D03D 15/533; D03D 15/292; D03D 15/25; D03D 15/47; D01F 1/10; D01F 6/60; D06M 13/352

(52) U.S. Cl. CPC A41D 31/08; D03D 15/283; D03D 15/513; D03D 15/533; D03D 15/292; D03D 15/25; D03D 15/47; D01F 1/106; D01F 6/605; D06M 13/352; D10B 2331/021; D10B 2401/04; D10B 2401/22; D10B 2401/16; D06M 2101/36

(57) ABSTRACT

The invention addresses the problem of providing a cloth and a protective product, which are excellent not only in flame retardancy but also in protection performance against electric arcs, and can further be provided with any color appearance. As a means for resolution, in a cloth including a flame-retardant fiber, a UV absorber or carbon particles are contained in the cloth, and the cloth is configured to have a lightness index L-value of 25 or more.

### TECHNICAL FIELD

The present invention relates to a cloth and a protective product, which are excellent not only in flame retardancy but also in protection performance against electric arcs, and can further be provided with any color appearance.

### BACKGROUND ART

Those who work near electrical equipment and ambulance officers who deal with accidents near electrical equipment may be subconsciously exposed to electric arcs or flash fires. An electric arc is an extremely cataclysmic phenomenon usually accompanied by an electricity of thousands of volts and thousands of amperes. When arcing occurs, due to a potential difference between two electrodes (i.e., voltage), gas molecules are ionized to form a plasma, and, as a result, electricity flows therein. That is, it refers to a phenomenon in which a current flows in a gas that is usually non-conductive. For protection from such electric arcs and flash fires, cloths using various flame-retardant fibers have been proposed. For example, PTL 1 proposes a cloth using an aramid fiber containing carbon particles.

However, although such a cloth has arc protection performance, it contains a large amount of carbon particles and thus has a limited selection of colors.

### CITATION LIST

### Patent Literature

PTL 1: WO 2017/094477

### SUMMARY OF INVENTION

### Technical Problem

The invention has been accomplished against the above background. An object thereof is to provide a cloth and a protective product, which are excellent not only in flame retardancy but also in protection performance against electric arcs, and can further be provided with any color appearance.

### Solution to Problem

The present inventors have conducted extensive research to solve the above problems. As a result, they have found that when cloth-forming fibers and the like are tailored with ingenuity, such a cloth is not only excellent in flame retardancy but also has improved protection performance against electric arcs, and can also be provided with any color hue. As a result of further extensive research, they have accomplished the invention.

Thus, the invention provides “a cloth including a flame-retardant fiber, the cloth being characterized by containing a UV absorber or carbon particles and having a lightness index L-value of 25 or more.”

In this case, it is preferable that the flame-retardant fiber is a meta-type wholly aromatic polyamide fiber containing the UV absorber. In addition, it is preferable that the UV absorber is fixed to the cloth with a binder resin. In addition, it is preferable that the UV absorber is at least one kind selected from the group consisting of salicylic acid-based compounds, benzophenone-based compounds, benzotriazole-based compounds, benzoxazine-based compounds, bisphenol-based compounds, and metal oxides. In addition, it is preferable that the content of the UV absorber is within a range of 0.2 to 5.0 wt % based on the cloth weight.

In the cloth of the invention, it is preferable that the average absorption coefficient for incident light at a wavelength of 200 to 400 nm is 90% or more. In addition, it is preferable that the flame-retardant fiber is a meta-type wholly aromatic polyamide fiber containing the carbon particles. In this case, it is preferable that the carbon particles have an average particle size of 0.1 μm or less. In addition, it is preferable that the content of the carbon particle is 0.5 wt % or less based on the cloth weight. In addition, it is preferable that the cloth further includes a fiber containing an agent having IR absorption performance and/or electrical conduction performance. In addition, it is preferable that the ATPV value as measured by Arc Resistance Test ASTM F1959-1999 is 8.0 cal/cm² or more. In addition, it is preferable that the afterglow time as measured by Flammability Test described in ISO 15025: 2000 Procedure B method is 1 second or less.

The invention also provides a protective product using the cloth described above and selected from the group consisting of arc protective garments, flameproof protective garments, work garments, activity garments, hats, gloves, aprons for protection, and members for protection.

### Advantageous Effects of Invention

According to the invention, a cloth and a protective product, which are excellent not only in flame retardancy but also in protection performance against electric arcs, and can further be provided with any color appearance, are obtained.

### DESCRIPTION OF EMBODIMENTS

Hereinafter, embodiments of the invention will be described in detail. The flame-retardant fiber used in the invention is a flame-retardant fiber having an LOI of 25 or more in accordance with JIS L 1091 (1999) E-2 method.

As such a flame-retardant fiber, for example, wholly aromatic polyamide fibers such as meta-type wholly aromatic polyamide fibers (meta-aramid fibers) and para-type wholly aromatic polyamide fibers (para-aramid fibers), polybenzimidazole fibers, polyimide fibers, polyamideimide fibers, polyetherimide fibers, polyarylate fibers, polyparaphenylene benzobisoxazole fibers, Novoloid fibers, flame-retardant acrylic fibers, polychlal fibers, flame-retardant polyester fibers, flame-retardant cotton fibers, flame-retardant rayon fibers, flame-retardant vinylon fibers, flame-retardant wool fibers, and the like can be mentioned. They may be used alone or as a mixture.

Further, it is preferable that the flame-retardant fiber has a melting point of 300° C. or more. Examples of such fibers include wholly aromatic polyamide fibers (meta-type wholly aromatic polyamide fibers or para-type wholly aromatic polyamide fibers), polybenzimidazole fibers, polyimide fibers, polyamideimide fibers, and polyacrylonitrile oxide fibers.

It is particularly preferable that the flame-retardant fiber has an LOI of 26 or more and a melting point of 400° C. or more. Examples of such fibers include wholly aromatic polyamide fibers (meta-type wholly aromatic polyamide fibers or para-type wholly aromatic polyamide fibers).

Here, a meta-type wholly aromatic polyamide fiber is a fiber made of a polymer wherein 85 mol % or more of its repeating units are m-phenyleneisophthalamide. Such a meta-type wholly aromatic polyamide may also be a copolymer containing a third component within a range of less than 15 mol %.

Such a meta-type wholly aromatic polyamide can be produced by a conventionally known interfacial polymerization method. As the polymerization degree of the polymer, it is preferable to use one having an intrinsic viscosity (I.V.) within a range of 1.3 to 1.9 dl/g as measured with an N-methyl-2-pyrrolidone solution having a concentration of 0.5 g/100 ml.

The above meta-type wholly aromatic polyamide may contain an alkylbenzenesulfonic acid onium salt. Preferred examples of alkylbenzenesulfonic acid onium salts include compounds such as a hexylbenzenesulfonic acid tetrabutylphosphonium salt, a hexylbenzenesulfonic acid tributylbenzylphosphonium salt, a dodecylbenzenesulfonic acid tetraphenylphosphonium salt, a dodecylbenzenesulfonic acid tributyltetradecylphosphonium salt, a dodecylbenzenesulfonic acid tetrabutylphosphonium salt, and a dodecylbenzenesulfonic acid tributylbenzylammonium salt. Among them, particularly preferred examples are a dodecylbenzenesulfonic acid tetrabutylphosphonium salt and a dodecylbenzenesulfonic acid tributylbenzylammonium salt as they are easy to obtain, have excellent thermal stability, and also have high solubility in N-methyl-2-pyrrolidone.

In order to obtain a sufficient improving effect on dyeability, it is preferable that the content of the above alkylbenzenesulfonic acid onium salt is within a range of 2.5 mol % or more, preferably 3.0 to 7.0 mol %, relative to poly-m-phenylene isophthalamide.

In addition, as a method for mixing poly-m-phenylene isophthalamide and an alkylbenzenesulfonic acid onium salt, a method in which poly-m-phenylene isophthalamide is mixed and dissolved in a solvent, and then an alkylbenzenesulfonic acid onium salt is dissolved in the solvent, is used, for example. Any of such methods may be used. The dope thus obtained is formed into fibers by a conventionally known method.

As the polymer used for a meta-type wholly aromatic polyamide fiber, for the purpose of improving dyeing affinity or discoloration resistance, for example, it is also possible that into an aromatic polyamide backbone having a repeating structural unit represented by the following formula (1), an aromatic diamine component or aromatic dicarboxylic acid halide component, which is different from a main unit of the repeating structure, is copolymerized as a third component to make 1 to 10 mol % of the total amount of repeating structural units in the aromatic polyamide.

—(NH—Ar1—NH—CO—Ar1—CO) formula (1)

Here, Ar1 is a divalent aromatic group having a linking group in the meta-position or in the axially non-parallel direction.

In addition, copolymerization as a third component is also possible. As specific examples of aromatic diamines represented by formulae (2) and (3), for example, p-phenylenediamine, chlorophenylenediamine, methylphenylenediamine, acetylphenylenediamine, aminoanisidine, benzidine, bis(aminophenyl)ether, bis(aminophenyl)sulfone, diaminobenzanilide, diaminoazobenzene, and the like can be mentioned. As specific examples of aromatic dicarboxylic acid dichlorides represented by formulae (4) and (5), for example, terephthalic acid chloride, 1,4-naphthalenedicarboxylic acid chloride, 2,6-naphthalenedicarboxylic acid chloride, 4,4′-biphenyldicarboxylic acid chloride, 5-chloroisophthalic acid chloride, 5-methoxyisophthalic acid chloride, bis(chlorocarbonylphenyl)ether, and the like can be mentioned.

H₂N—Ar2—NH₂ formula (2)

H₂N—Ar2—Y—Ar2—NH₂ formula (3)

XOC—Ar3—COX formula (4)

XOC—Ar3—Y—Ar3—COX formula (5)

Here, Ar2 is a divalent aromatic group different from Ar1, Ar3 is a divalent aromatic group different from Ar1, Y is at least one atom or functional group selected from the group consisting of an oxygen atom, a sulfur atom, and an alkylene group, and X represents a halogen atom.

In addition, with respect to the crystallinity of the meta-type wholly aromatic polyamide fiber, 5 to 35% is preferable in that the dye exhaustion is good, and the color can be easily adjusted as intended even with a reduced amount of dye or under weak dyeing conditions. Further, 15 to 25% is more preferable in that uneven distribution of the dye on the surface is less likely to occur, and the discoloration resistance is also high, and also that the practically necessary dimensional stability can be ensured.

In addition, with respect to the residual solvent content of the meta-type wholly aromatic polyamide fiber, 0.1 wt % or less (preferably 0.001 to 0.1 wt %) is preferable in that the excellent flame retardation performance of the meta-type aromatic polyamide fiber is not impaired.

The meta-type wholly aromatic polyamide fiber can be produced by the following method. In particular, by the method described below, the crystallinity and residual solvent content can be made within the above ranges.

The polymerization method for a meta-type wholly aromatic polyamide polymer does not have to be particularly limited, and it is possible to use, for example, the solution polymerization method or interfacial polymerization method described in JP-B-35-14399, U.S. Pat. No. 3,360,595, JP-B-47-10863, etc.

The spinning solution does not have to be particularly limited. It is possible to use an amide-based solvent solution containing an aromatic copolyamide polymer obtained by the above solution polymerization or interfacial polymerization, for example, and it is also possible that the polymer is isolated from the polymerization solution, dissolved in an amide-based solvent, and used.

Examples of amide-based solvents used here include N,N-dimethylformamide, N,N-dimethylacetamide, N-methyl-2-pyrrolidone (NMP), and dimethyl sulfoxide.

When the copolymerized aromatic polyamide polymer solution obtained as above further contains an alkali metal salt or alkaline earth metal salt, the solution is further stabilized and becomes usable at higher concentrations and lower temperatures; therefore, this is preferable. The alkali metal salt or alkaline earth metal salt is preferably 1 mass % or less, more preferably 0.1 mass % or less, based on the total weight of the polymer solution.

In a spinning/coagulation step, the spinning solution obtained above (meta-type wholly aromatic polyamide polymer solution) is extruded into a coagulation liquid and coagulated.

The spinning apparatus is not particularly limited, and a conventionally known wet spinning apparatus can be used. In addition, as long as wet spinning can be stably performed, there is no need to particularly limit the number of spinning holes of the spinneret, their arrangement, the hole shape, and the like. For example, it is possible to use a multi-hole spinneret for staple fibers, in which the number of holes is 1,000 to 30,000 and the spinning hole diameter is 0.05 to 0.2 mm, or the like.

In addition, as the temperature of the spinning solution (meta-type wholly aromatic polyamide polymer solution) upon extrusion from the spinneret, a range of 20 to 90° C. is suitable.

As a coagulation bath used to obtain fibers, an aqueous solution containing substantially no inorganic salt and having an amide-based solvent, preferably NMP, concentration of 45 to 60 mass % is used at a bath liquid temperature within a range of 10 to 50° C. When the amide- based solvent (preferably NMP) concentration is less than 45 wt %, this results in a thick-skin structure, and the washing efficiency in a washing step decreases, making it difficult to reduce the residual solvent content of the fiber. Meanwhile, in the case where the amide-based solvent (preferably NMP) concentration is more than 60 wt %, uniform coagulation inside fibers may not be achieved, making it difficult, also in this case, to reduce the residual solvent content of the fiber. Incidentally, as the fiber immersion time in the coagulation bath, a range of 0.1 to 30 seconds is suitable.

Subsequently, the fiber is drawn to a draw ratio of 3 to 4 in a plastic drawing bath containing an aqueous solution having an amide-based solvent (preferably NMP) concentration of 45 to 60 wt % at a bath liquid temperature within a range of 10 to 50° C. After drawing, the fiber is thoroughly washed with an aqueous solution at 10 to 30° C. having an NMP concentration of 20 to 40 wt % and then through a hot water bath at 50 to 70° C.

The fiber after washing is subjected to a dry heat treatment at a temperature of 270 to 290° C. As a result, a meta-type aromatic polyamide fiber that satisfies the above crystallinity and residual solvent content ranges can be obtained.

In addition, the para-type wholly aromatic polyamide fiber is, as represented by Technora®, Kevlar®, and

Twaron®, a fiber made of a polyamide having an aromatic ring in the main chain, and may be poly-p-phenylene terephthalamide (PPTA) or may also be copolyparaphenylene-3,4′oxydiphenylene terephthalamide (PPODPA), which is a copolymer type.

In addition to the flame-retardant fiber described above, the cloth of the invention may further contain fibers such as polyether ether ketone (PEEK) fibers, melamine fibers, phenol fibers, fluorine-based fibers, polyphenylene sulfide (PPS) fibers, polyester fibers, acrylic fibers, acrylic-based fibers, aliphatic polyamide fibers, electrically conductive fibers, cellulose fibers, wool, and silk. In addition, the cloth may contain a fiber containing an agent having IR absorption performance and/or electrical conduction performance.

In the fiber contained in the cloth of the invention (the above flame-retardant fiber, etc.), the fiber may be a long fiber (multifilament) or short fiber. In particular, for blend-spinning with other fibers, a short fiber having a fiber length of 25 to 200 mm (more preferably 30 to 150 mm) is preferable. In addition, it is preferable that the single fiber fineness is within a range of 0.5 to 5 dtex.

The cloth of the invention contains at least either of a UV absorber and carbon particles (carbon black). It is also possible to contain both. In this case, the UV absorber and/or carbon particles may be contained in the cloth-forming fiber (e.g., the above flame-retardant fiber, etc.), or may also be attached to the surface of the cloth. In addition, the UV absorber and carbon particles may be contained in the same fiber or may also be contained in different fibers. As the content of the UV absorber, in terms of protection performance against electric arcs, the content is preferably 0.2 wt % or more (more preferably 0.2 to 5.0 wt %, still more preferably 0.25 to 3.0 wt %) based on the cloth weight. In addition, as the content of the carbon particles, in terms of simultaneously achieving any color appearance and protection performance against electric arcs, the content is preferably 0.5 wt % or less (more preferably 0.01 to 0.5 wt %, still more preferably 0.1 to 0.5 wt %) based on the cloth weight. When the cloth contains more than 0.5 wt % of carbon particles, the lightness index L-value of the cloth may decrease. When the carbon particle content is 0.5 wt % or less based on the cloth weight, the hue of the cloth can be made clearer.

For example, the flame-retardant fiber may contain a UV absorber. In this case, the UV absorber content is preferably 1.0 to 3.0 wt % based on the fiber weight. The UV absorber is not particularly limited as long as it has a UV absorbing effect. For example, salicylic acid-based compounds, benzophenone-based compounds, benzotriazole-based compounds, benzoxazine-based compounds, bisphenol-based compounds, metal oxides (e.g., titanium oxide, antimony oxide, zinc oxide, tin oxide, etc.), and the like can be mentioned.

In addition, the flame-retardant fiber may contain carbon particles. In this case, the carbon particle content is preferably 0.1 to 3.0 wt % based on the fiber weight. The average particle size of carbon particles is preferably 0.1 μm or less (more preferably 0.01 to 0.1 μm). In the case where the average particle size is more than 0.1 μm, it may happen that a structure or cluster, which is a secondary structural unit, forms defective foreign substances as coarse agglomerates in the fiber, and these defective foreign substances cause single-yarn breakage, resulting in fluff formation and yarn breakage.

The flame-retardant fiber may further contain additives such as antioxidants, heat stabilizers, flame retardants, delusterants, colorants, and inert fine particles.

Here, the flame-retardant fiber containing a UV absorber or carbon particles is preferably a meta-type wholly aromatic polyamide fiber and/or a para-type wholly aromatic polyamide fiber. In this case, in terms of durability, it is preferable that the UV absorber or carbon particles are contained in the polymer forming the meta-type wholly aromatic polyamide fiber or para-type wholly aromatic polyamide fiber, but they may also be attached to the fiber surface.

In the cloth of the invention, for example, it is preferable that the meta-type wholly aromatic polyamide fiber containing a UV absorber is 30 to 99 wt % based on the cloth weight. In addition, it is preferable that the meta-type wholly aromatic polyamide fiber is 30 to 95 wt % (more preferably 60 to 85 wt %) based on the cloth weight, the para-type wholly aromatic polyamide fiber is 3 to 40 wt % (more preferably 5 to 35 wt %) based on the cloth weight, and the fiber containing an agent having IR absorption performance and/or electrical conduction performance is 2 to 30 wt %. Here, it is preferable that the total of the meta-type wholly aromatic polyamide fiber, the para-type wholly aromatic polyamide fiber, and the fiber containing an agent having IR absorption performance and/or electrical conduction performance is 100 wt %. In addition, it is preferable that the total of the meta-type wholly aromatic polyamide fiber and the para-type wholly aromatic polyamide fiber is 100 wt %.

The cloth of the invention can be produced, for example, by the following production method. For example, a spun yarn is obtained using the flame-retardant fiber as described above and other fibers as necessary. In this case, it is preferable that the meta-type wholly aromatic polyamide fiber containing a UV absorber is contained in an amount of 30 to 99 wt % (more preferably 40 to 90 wt %) based on the spun yarn weight.

Here, it is preferable that the cloth-forming fibers are blended, and contained in the cloth as a blended yarn. The blended yarn may be obtained from the above fibers by mixing with cotton or blending in the usual manner, but may also be, according to the expected functional characteristics, a composite yarn using a sheath-core two-layered spun yarn, a core-spun yarn, or a stretch-broken yarn. In this case, it is preferable that the fiber length of each fiber is 25 to 200 mm (more preferably 30 to 150 mm). Incidentally, the fiber lengths of fibers may be the same or different from each other.

In this case, in terms of resistance to yarn breakage, strength, and the like, the fineness of the spun yarn (count) is preferably a cotton count (Ecc) of 20 to 60. The number of single yarns forming the spun yarn is preferably 60 or more (more preferably 60 to 300), and the raw-cotton single fiber fineness is preferably 0.5 to 5.0 dtex (more preferably 0.5 to 3.0 dtex). The twist coefficient (first twist coefficient) of the spun yarn is preferably within a range 2.0 to 4.2 (more preferably 3.0 to 4.0). With an increase in the twist coefficient, the fluff is settled, and the pilling resistance of the cloth improves. On the other hand, the spun yarn becomes rigid, whereby the elongation may decrease, resulting in a decrease in the tear strength of the cloth, or the cloth may be hardened. Incidentally, the twist coefficient is expressed by the following equation.

Twist coefficient=the number of twists (twists/2.54 cm)/the cotton count of the spun yarn (Ecc)^{1/2}

The spinning method for the spun yarn may be innovative spinning, such as ring spinning, MTS, MJS, or MVS, or an ordinary spinning method, such as ring spinning. The twist direction may be Z-direction or S-direction.

Next, the spun yarn is twist set as necessary (vacuum steam setting), and then two or more of such spun yarns (preferably two to four yarns, particularly preferably two yarns) are aligned, combined, and plied. Examples of twisting machines used for plying include twisting machines such as an up-twister, a covering machine, an Italian twisting machine, and a double twister.

In this case, the twisting direction in plying (second twisting) may be the additional twisting direction or reverse twisting direction. In addition, the number of twists is preferably 500/m or more, more preferably 700 to 3,000/m, and particularly preferably 900 to 2,000/m. In the case where the number of twists is less than 500/m, after twist setting and untwisting, the resulting spun yarn may not be in coiled form. In addition, in the case where the number of twists is 3,000/m or more, the untwisting torque may be high even after twist setting, causing a problem with workability during the weaving of a woven fabric in the next step.

Next, the plied yarn is twist set (high-pressure vacuum steam setting as in twist setting for conventional aramid double-ply yarns). In the case where firm twist setting has to be imparted, the number of times of twist setting may be increased, or the twist setting temperature or setting time may be changed. For example, the setting temperature may be 60 to 125° C., the setting time may be 20 to 40 minutes, and the number of times may be 1 to 3, but a higher setting temperature or a longer setting time results in better setting properties and thus is more preferable. The setting properties can be further enhanced by increasing the number of times of twist setting, prolonging the treatment time, or raising the temperature. Considering the production management (the safety of work management, quality management, etc.) and the production and processing cost, it is preferable to prolong the treatment time. In addition, a higher degree of vacuum results in improved quality and thus is more preferable.

In addition, the raw cotton used for the spun yarn may be dyed (yarn-dyed) raw cotton or spun-dyed raw cotton, or it is also possible to use raw cotton that has been subjected to a functionalization treatment (sweat absorption, quick drying, stain resistance, flame retardancy, etc.).

The method for producing the cloth of the invention is not particularly limited, and may be any known method. For example, it is possible that at least a flame-retardant fiber (meta-type wholly aromatic polyamide fiber, etc.) is mixed with cotton to obtain a spun yarn, and then, as a single yarn or a double-ply yarn, woven using a rapier loom or the like.

In the invention, the structure of the cloth is not particularly limited, and preferred examples thereof include woven fabric structures such as three foundation weaves including plain weave, twill weave, and satin weave, modified weaves, modified weaves such as modified twill weave, and one-side backed weaves such as warp backed weave and weft backed weave. A woven fabric having such a woven fabric structure can be woven by an ordinary method using an ordinary weaving machine such as a rapier loom or an air-jet weaving machine. The number of layers is not particularly limited either, and the woven fabric may be mono-layered, or may also have a multi-layered structure including two or more layers. Incidentally, the cloth may also be a knitted fabric.

In addition, the knitting or weaving of the cloth is preferably followed by post-processing. Examples of specific post-processing steps include steps such as scouring, drying, relaxing, singeing, dyeing, and functionalization treatments. The scouring or relaxing treatment may be an open-width treatment or may also be a jet scouring/relaxing treatment. A specific example is a method in which the cloth is treated with an open-width non-tension machine during continuous scouring or continuous drying. Such a method uses, for example, a Sofcer scouring machine, a tenter dryer, a shrink surfer, a short loop, a Luciole dryer, or the like. In addition, in some cases, the scouring or relaxing step may be omitted.

In particular, in the invention, in terms of obtaining a cloth with a high-quality appearance, which can be provided with any color hue, in the case where the cloth contains a meta-type wholly aromatic polyamide fiber, it is preferable that the meta-type wholly aromatic polyamide fiber is colored with a dye. The dye is preferably a cationic dye.

A cationic dye refers to a water-soluble dye that is soluble in water and has a basic group, and has been commonly used in the dyeing of acrylic fibers, natural fibers, or cationic-dyeable polyester fibers. As cationic dyes, for example, diacrylic methane dyes, triacrylic methane dyes, quinoneimine (azine, oxazine, thiazine) dyes, xanthene dyes, methine dyes (polymethine, azamethine), heterocyclic azo dyes (thiazole azo, triazole azo, benzothiazole azo), anthraquinone dyes, and the like can be mentioned. In addition, in recent years, dispersed cationic dyes obtained by blocking basic groups are also available, and both can be used. Among them, azo dyes are preferable.

The cloth of the invention is preferably subjected to dyeing processing in a dyeing bath containing a cationic dye as described above. In this case, it is preferable to employ a method in which dyeing is performed at 115 to 135° C., followed by a reduction clearing treatment and drying, for example.

In addition, in the cloth dyeing processing, it is preferable to use a carrier agent, and it is possible to employ a dyeing treatment in a bath containing both the cationic dye and the carrier agent. In addition, when the cloth is treated with a special surfactant before the cationic dyeing, deeper dyeing can be achieved by open-width dyeing.

Here, it is preferable that the carrier agent is, for example, at least one kind selected from DL-β-ethylphenethyl alcohol, 2-ethoxybenzyl alcohol, 3-chlorobenzyl alcohol, 2,5-dimethylbenzyl alcohol, 2-nitrobenzyl alcohol, p-isopropylbenzyl alcohol, 2-methylphenethyl alcohol, 3-methylphenethyl alcohol, 4-methylphenethyl alcohol, 2-methoxybenzyl alcohol, 3-iodobenzyl alcohol, cinnamic alcohol, p-anisyl alcohol, benzhydrol and cyclohexyl pyrrolidone. The amount of carrier agent is preferably 1 to 10 parts by weight, more preferably 1 to 5 parts by weight, per 100 parts by weight of the flame-retardant fiber (meta-type wholly aromatic polyamide fiber, etc.).

In addition, in the cloth of the invention, the UV absorber may be fixed to the cloth surface (the surface of the cloth-forming fiber) with a binder resin. Here, the UV absorber may be fixed to both sides (entire surface) of the cloth, or may be also fixed to only one side. In this case, the amount of UV absorber fixed to the cloth is preferably within a range of 0.02 to 50 g/m² (more preferably 0.1 to 30 g/m²) relative to the cloth. When the amount of UV absorber fixed is lower than this range, it may happen that the cloth cannot completely absorb the electromagnetic wave energy of electric arcs, resulting in an insufficient suppressing effect on the energy that reaches the human body. Conversely, when the amount of UV absorber fixed is greater than this range, although the effect is sufficient, this is not economical.

Here, the binder resin is not particularly limited, and examples thereof include urethane resin, acrylic resin, polyester resin, silicone resin, vinyl chloride resin, and nylon resin. The amount of binder resin fixed is, based on resin solids, preferably within a range of 0.01 to 40 g/m² (more preferably 1 to 30 g/m²) relative to the cloth. Usually, the UV absorber and the binder resin are imparted to the cloth as a blend composition of the two. In this case, the blend composition may be either an aqueous or solvent-based composition, but is preferably an aqueous composition in terms of the work environment in the processing steps. Examples of solvents include toluene, isopropyl alcohol, dimethylformamide, methyl ethyl ketone, and ethyl acetate. In the blend composition, an epoxy-based or like crosslinking agent may be used together. Further, for the purpose of improving attachment to the cloth itself, etc., appropriate additives may further be used together.

The blending ratio of the UV absorber and the binder resin (based on resin solids) is preferably within a range of 1:0.1 to 1:50 (more preferably 1:0.5 to 1:40). When the proportion of the binder resin blended is lower than this range, after the cloth is formed into a protective product, the UV absorber is likely to come off during washing, whereby the protection performance against electric arcs may decrease. Conversely, when the proportion of the binder resin blended is greater than this range, the flame retardancy of the cloth may decrease.

As a means for imparting a UV absorber and a binder resin to the cloth, it is possible that after first forming the two into a blend composition as described above, the blend composition is imparted using a known imparting means such as a padding method, a gravure coating method, or a screen printing method.

Here, the UV absorber used is not particularly limited as long as it has a UV absorbing effect. For example, salicylic acid-based compounds, benzophenone-based compounds, benzotriazole-based compounds, benzoxazine-based compounds, bisphenol-based compounds, metal oxides (e.g., titanium oxide, antimony oxide, zinc oxide, tin oxide, etc.), and the like can be mentioned. When the cloth containing such a UV absorber is used for a work garment or the like, and the wearer is involved in an electric arc accident, the UV absorber absorbs the electromagnetic wave energy generated by the accident, thereby suppressing the energy that reaches the human body, making it possible to suppress damage to the human body.

In this case, as described above, the UV absorber content is preferably within a range of 0.2 to 5.0 wt % (more preferably 0.25 to 3.0 wt %) based on the cloth weight.

In addition, for improving other properties, it is also possible to additionally apply shaving and/or singeing, and/or other various kinds of function-imparting processing with a sweat absorbent, a water repellent, a heat storage agent, an antistatic agent, an antibacterial agent, a deodorant, an insect repellent, a mosquito repellent, a mosquito repellent, a phosphorescent agent, a retroreflective agent, or the like. Here, the sweat absorbent is preferably polyethylene glycol diacrylate, a polyethylene glycol diacrylate derivative, a polyethylene terephthalate-polyethylene glycol copolymer, or a water-soluble polyurethane. As methods for imparting a sweat absorbent to the cloth, a method that performs a padding treatment, a method in which, at the time of dyeing processing, a treatment is performed in the same bath containing the dyeing liquid, and the like can be mentioned, for example.

In the cloth thus obtained, it is preferable that the cloth has a weight per unit within a range of 120 to 260 g/m² (more preferably 150 to 240 g/m²). When the weight per unit is lower than this range, in the case where the cloth is used in a work garment and involved in an electric arc accident, the suppressing effect on the electromagnetic waves or thermal energy that reaches the human body may be insufficient. Conversely, when the weight per unit is greater than this range, although the effect is sufficient, as a work garment, the wearing comfort or the ease of activity may decrease.

In addition, in the cloth of the invention, it is preferable that the average absorption coefficient for incident light having a wavelength of 200 to 400 nm (ultraviolet boundary region) is 90% or more (more preferably 90 to 99%). The average absorption coefficient can be measured with “UV3100S MPC-3100” manufactured by Shimadzu Corporation.

In addition, in the cloth, it is important that the lightness index L-value is 25 or more (more preferably 30 or more, still more preferably 40 to 80). The work garments worn by workers at electric power companies or chemical companies, firefighters, or paramedics, for example, are required to have high lightness for recognition and visibility. In the case where the lightness index L-value is less than 25, the hue is dark like black or dark blue, and the recognition and visibility are low, which is not undesirable for work garments that need to be colored.

In addition, in the cloth of the invention, it is preferable that the ATPV value in Arc Resistance Test ASTM F1959-1999 is 8.0 cal/cm² or more (more preferably 8.0 to 10.0 cal/cm²).

In addition, when the cloth is used for work garments, flame retardation performance against flash fires is also required, and it is preferable that the afterglow time as measured by Flammability Test described in ISO 15025: 2000 Procedure B method is 1 second or less (more preferably 0.01 to 1 second).

The cloth of the invention is configured as above, and it is thus possible to obtain a cloth which has excellent protection performance against electric arcs, is resistant to flash fires, and further has any color hue.

The protective product of the invention is a protective product using the cloth described above and selected from the group consisting of arc protective garments, flame-proof protective garments, work garments, activity garments, hats (including hoods, hoods, etc.), gloves (including arm covers, etc.), aprons for protection, and members for protection. The work garments include work garments for works in a steel plant or steel factory, work garments for welding, and work garments for use in an explosion-proof area. In addition, the gloves include work gloves used in the aircraft industry, the information equipment industry, the precision machinery industry, and the like where precision components are treated. In such a protective product, it is preferable that the front surface of the cloth is used as the outer air side, while the back surface is used as the skin side.

Such a protective product uses the above cloth and thus has not only flame retardancy but also resistance to flash fires (protection force), and can further be provided with any color hue. In addition, the product also has excellent lightweight properties and thus has excellent wearing comfort and safety. Incidentally, with respect to the resistance to flash fires (protection force), with an increase in the number of layers of the cloth stacked like quilting (quilt stitch), the resistance (protection force) improves.

### Examples

Next, examples of the invention and comparative examples will be described in detail, but the invention is not limited thereto.

### (1) Average Absorption Coefficient for Incident Light at 200 to 400 nm

The average absorption coefficient for incident light in a wavelength range of 200 to 400 nm was measured with “UV3100S MPC-3100” manufactured by Shimadzu Corporation.

### (2) Lightness Index L-Value

The lightness index L-value was measured with a Macbeth spectrophotometer (Color-Eye 3100).

### (3) ATPV Value

The ATPV value was measured in accordance with Arc Resistance Test ASTM F1959-1999. 8.0 cal/cm² or more was rated as acceptable (Level 2 cleared).

### (4) Flame Retardancy

The afterglow time was measured in accordance with Flammability Test described in ISO 15025: 2000 Procedure B method. 1 second or less was rated as acceptable.

### (5) Weight per Unit of Woven Fabric

Measurement was performed in accordance with JIS L1096: 2010 A method.

### Example 1

Using a meta-type wholly aromatic polyamide fiber having kneaded therein a UV absorber (benzotriazole-based compound) in an amount of 3.0 wt% based on the fiber weight and containing no carbon particles (single fiber fineness: 1.7 dtex, fiber length: 51 mm) and a para-type wholly aromatic polyamide fiber (manufactured by Teijin Aramid, “Twaron”®, single fiber fineness: 1.7 dtex, fiber length: 50 mm), a spun yarn with a cotton count of 40/1 was formed at 23.4 twists/2.54 cm (twist direction: Z) such that the meta-type wholly aromatic polyamide fiber: 95 wt % and the para-type wholly aromatic polyamide fiber: 5 wt %, and then, at 23.4 twists/2.54 cm (twist direction: S), a double-ply twisted yarn (A) was obtained.

Next, using the double-ply twisted yarn (A) as warp and weft, a woven fabric having a warp density of 78 yarns/2.54 cm and a weft density of 42 yarns/2.54 cm was woven by twill weaving (2/1 twill structure).

The obtained undyed woven fabric (gray fabric) was desized, scoured, and dried in the usual manner, and then, using a jet dyeing machine, the fabric was dyed in a dye bath containing a cationic dye (for beige color) and a carrier agent for 60 minutes at a temperature of 130° C. raised from ambient temperature. Subsequently, finish setting was performed.

In the obtained cloth (arc protective woven fabric), the warp density was 83 yarns/2.54 cm, the weft density was 46 yarns/2.54 cm, the UV absorber content was 2.9 wt % based on the cloth weight, the average absorption coefficient for incident light at 200 to 400 nm was 95%, the lightness index L-value was 42, and the weight per unit was 182 g/m². The afterglow time in the flammability test was 0.8 seconds, and the ATPV value was as excellent as 8.6 cal/cm². In addition, the surface had a beige color appearance.

### Example 2

For warp, using a meta-type wholly aromatic polyamide fiber containing no UV absorber or carbon particles (manufactured by Teijin Limited, “Teijinconex NEO”®, single fiber fineness: 1.7 dtex, fiber length: 51 mm) and a para-type wholly aromatic polyamide fiber (manufactured by Teijin Aramid, “Twaron”®, single fiber fineness: 1.7 dtex, fiber length: 50 mm), a spun yarn with a cotton count of 40/1 was formed at 23.4 twists/2.54 cm (twist direction: Z) such that the meta-type wholly aromatic polyamide fiber: 95 wt % and the para-type wholly aromatic polyamide fiber: 5 wt %, and then, at 23.4 twists/2.54 cm (twist direction: S), a double-ply twisted yarn (A) was obtained.

In addition, for weft, using a meta-aromatic polyamide fiber having kneaded therein a UV absorber (benzotriazole-based compound) in an amount of 3.0 wt% and containing no carbon particles (single fiber fineness: 2.2 dtex, fiber length: 51 mm) and a para-type wholly aromatic polyamide fiber (manufactured by Teijin Aramid, “Twaron”®, single fiber fineness: 1.7 dtex, fiber length: 50 mm), a spun yarn with a cotton count of 40/1 was formed at 23.4 twists/2.54 cm (twist direction: Z) such that the meta-type wholly aromatic polyamide fiber: 95 wt % and the para-type wholly aromatic polyamide fiber: 5 wt %, and then, at 23.4 twists/2.54 cm (twist direction: S), a double-ply twisted yarn (B) was obtained.

Next, using the double-ply twisted yarn (A) as warp and the double-ply twisted yarn (B) as weft, a woven fabric having a warp density of 77 yarns/2.54 cm and a weft density of 52 yarns/2.54 cm was woven by twill weaving (2/1 twill structure).

The obtained undyed woven fabric (gray fabric) was desized, scoured, and dried in the usual manner, and then, using a jet dyeing machine, the fabric was dyed in a dye bath containing a cationic dye (for beige color) and a carrier agent for 60 minutes at a temperature of 130° C. raised from ambient temperature. Subsequently, finish setting was performed.

In the obtained cloth (arc protective woven fabric), the warp density was 80 yarns/2.54 cm, the weft density was 57 yarns/2.54 cm, the UV absorber content was 1.2 wt% based on the cloth weight, the average absorption coefficient for incident light at 200 to 400 nm was 93%, the lightness index L-value was 38, and the weight per unit was 180 g/m². The afterglow time in the flammability test was 0.6 seconds, and the ATPV value was as excellent as 8.3 cal/cm². In addition, the surface had a beige color appearance.

### Example 3

Using a meta-aromatic polyamide fiber containing no UV absorber or carbon particles (manufactured by Teijin Limited, “Teijinconex NEO”®, single fiber fineness: 1.7 dtex, fiber length: 51 mm) and a para-type wholly aromatic polyamide fiber (manufactured by Teijin Aramid, “Twaron”®, single fiber fineness: 1.7 dtex, fiber length: 50 mm), a spun yarn with a cotton count of 40/1 was formed at 23.4 twists/2.54 cm (twist direction: Z) such that the meta-type wholly aromatic polyamide fiber: 95 wt % and the para-type wholly aromatic polyamide fiber: 5 wt %, and then, at 23.4 twists/2.54 cm (twist direction: S), a double-ply twisted yarn (A) was obtained.

Next, using the double-ply twisted yarn (A) as warp and weft, a woven fabric having a warp density of 78 yarns/2.54 cm and a weft density of 42 yarns/2.54 cm was woven by twill weaving (2/1 twill structure).

The obtained undyed woven fabric (gray fabric) was desized, scoured, and dried in the usual manner, and then, using a jet dyeing machine, the fabric was dyed in a dye bath containing a cationic dye (for beige color) and a carrier agent for 60 minutes at a temperature of 130° C. raised from ambient temperature. Subsequently, finish setting was performed to give a base fabric.

Next, the following blend composition was prepared.

### Composition of Blend Composition

Acrylic-based binder 3.0% (solids content: 40%)
Benzotriazole-based compound water dispersion 3.0% (solids content: 15%)
Water 95%

Next, the blend composition was imparted to the entire fiber surface of the woven base fabric by a padding method (benzotriazole-based compound content: 0.45 g/m², binder resin solids content: 1.2 g/m²), and then dried at 160° C. to give a cloth.

In the obtained cloth (arc protective woven fabric), the warp density was 84 yarns/2.54 cm, the weft density was 45 yarns/2.54 cm, the UV absorber content was 0.25 wt % based on the cloth weight, the average absorption coefficient for incident light at 200 to 400 nm was 91%, the lightness index L-value was 49, and the weight per unit was 183 g/m². The afterglow time in the flammability test was 0.9 seconds, and the ATPV value was as excellent as 8.1 cal/cm². In addition, the surface had a beige color appearance.

### Example 4

Using a meta-type wholly aromatic polyamide fiber having kneaded therein a UV absorber (titanium oxide) in an amount of 1.5 wt % based on the fiber weight and containing no carbon particles (single fiber fineness: 1.7 dtex, fiber length: 51 mm) and a para-type wholly aromatic polyamide fiber (manufactured by Teijin Aramid, “Twaron”®, single fiber fineness: 1.7 dtex, fiber length: 50 mm), a spun yarn with a cotton count of 40/1 was formed at 23.4 twists/2.54 cm (twist direction: Z) such that the meta-type wholly aromatic polyamide fiber: 95 wt % and the para-type wholly aromatic polyamide fiber: 5 wt %, and then, at 23.4 twists/2.54 cm (twist direction: S), a double-ply twisted yarn (A) was obtained.

Next, using the double-ply twisted yarn (A) as warp and weft, a woven fabric having a warp density of 78 yarns/2.54 cm and a weft density of 42 yarns/2.54 cm was woven by twill weaving (2/1 twill structure).

The obtained undyed woven fabric (gray fabric) was desized, scoured, and dried in the usual manner, and then, using a jet dyeing machine, the fabric was dyed in a dye bath containing a cationic dye (for beige color) and a carrier agent for 60 minutes at a temperature of 130° C. raised from ambient temperature. Subsequently, finish setting was performed.

In the obtained cloth (arc protective woven fabric), the warp density was 83 yarns/2.54 cm, the weft density was 46 yarns/2.54 cm, the UV absorber content was 2.9 wt % based on the cloth weight, the average absorption coefficient for incident light at 200 to 400 nm was 95%, the lightness index L-value was 44, and the weight per unit was 182 g/m². The afterglow time in the flammability test was 0.8 seconds, and the ATPV value was as excellent as 8.8 cal/cm². In addition, the surface had a beige color appearance.

### Comparative Example 1

Using a meta-aromatic polyamide fiber containing no UV absorber or carbon particles (manufactured by Teijin Limited, “Teijinconex NEO”®, single fiber fineness: 1.7 dtex, fiber length: 51 mm) and a para-type wholly aromatic polyamide fiber (manufactured by Teijin Aramid, “Twaron”®, single fiber fineness: 1.7 dtex, fiber length: 50 mm), a spun yarn with a cotton count of 40/1 was formed at 23.4 twists/2.54 cm (twist direction: Z) such that the meta-type wholly aromatic polyamide fiber: 95 wt % and the para-type wholly aromatic polyamide fiber: 5 wt %, and then, at 23.4 twists/2.54 cm (twist direction: S), a double-ply twisted yarn (A) was obtained.

Next, using the double-ply twisted yarn (A) as warp and weft, a woven fabric having a warp density of 78 yarns/2.54 cm and a weft density of 42 yarns/2.54 cm was woven by twill weaving (2/1 twill structure).

The obtained undyed woven fabric (gray fabric) was desized, scoured, and dried in the usual manner, and then, using a jet dyeing machine, the fabric was dyed in a dye bath containing a cationic dye (for beige color) and a carrier agent for 60 minutes at a temperature of 130° C. raised from ambient temperature. Subsequently, finish setting was performed.

In the obtained cloth, the warp density was 83 yarns/2.54 cm, the weft density was 46 yarns/2.54 cm, The UV absorber content was 0 wt % based on the cloth weight, the average absorption coefficient for incident light at 200 to 400 nm was 88%, the lightness index L-value was 41, the weight per unit was 182 g/m², and the afterglow time in the flammability test was 0.8 seconds. However, the ATPV value was as poor as 7.1 cal/cm².

### Example 5

For warp, using a meta-type wholly aromatic polyamide fiber containing no UV absorber or carbon particles (manufactured by Teijin Limited, “Teijinconex NEO”®, single fiber fineness: 1.7 dtex, fiber length: 51 mm), a para-type wholly aromatic polyamide fiber (manufactured by Teijin Aramid, “Twaron”®, single fiber fineness: 1.7 dtex, fiber length: 50 mm) , and an electrically conductive acrylic fiber as a fiber containing an agent having IR absorption performance and electrical conduction performance (eccentric sheath-core electrically conductive acrylic fiber, single fiber fineness: 3.3 dtex, fiber: 38 mm, sheath: acrylic/core: metal compound), a spun yarn with a cotton count of 40/1 was formed at 23.4 twists/2.54 cm (twist direction: Z) such that the meta-type wholly aromatic polyamide fiber: 80 wt %, the para-type wholly aromatic polyamide fiber: 5 wt %, the electrically conductive acrylic fiber: 15 wt %, and then, at 23.4 twists/2.54 cm (twist direction: S), a double-ply twisted yarn (A) was obtained.

For weft, using a meta-type wholly aromatic polyamide fiber having kneaded therein carbon particles with an average particle size of 0.08 μm in an amount of 1.1 wt % and containing no UV absorber (manufactured by Teijin Limited, “Teijinconex”®, single fiber fineness: 2.2 dtex, fiber length: 51 mm) and a para-type wholly aromatic polyamide fiber (manufactured by Teijin Aramid, “Twaron”®, single fiber fineness: 1.7 dtex, fiber length: 50 mm), a spun yarn with a cotton count of 40/1 was formed at 23.4 twists/2.54 cm (twist direction: Z) such that the meat-type wholly aromatic polyamide fiber: 95 mass % and the para-type wholly aromatic polyamide fiber: 5 mass %, and then, at 23.4 twists/2.54 cm (twist direction: S), a double-ply twisted yarn (B) was obtained.

Next, using the double-ply twisted yarn (A) as warp and the double-ply twisted yarn (B) as weft, a woven fabric having a warp density of 77 yarns/2.54 cm and a weft density of 52 yarns/2.54 cm was woven by twill weaving (2/1 twill structure).

The obtained undyed woven fabric (gray fabric) was desized, scoured, and dried in the usual manner, and then, using a jet dyeing machine, the fabric was dyed in a dye bath containing a cationic dye (for beige color) and a carrier agent for 60 minutes at a temperature of 130° C. raised from ambient temperature. Subsequently, finish setting was performed.

In the obtained cloth (arc protective woven fabric), the warp density was 80 yarns/2.54 cm, the weft density was 57 yarns/2.54 cm, the carbon particle content was 0.43 wt % based on the cloth weight, the lightness index L-value was 45, and the weight per unit was 182 g/m². The ATPV value was as excellent as 8.3 cal/cm². In addition, the surface had a beige color appearance.

### Example 6

A cloth (arc protective woven fabric) was obtained in the same manner as in Example 5, except that the cationic dye used in dyeing was a dye for blue color.

In the obtained cloth (arc protective woven fabric), the warp density was 81 yarns/2.54 cm, the weft density was 57 yarns/2.54 cm, carbon particle content was 0.43 wt % based on the cloth weight, the lightness index L-value was 35, and the weight per unit was 184 g/m². The ATPV value was as excellent as 8.6 cal/cm². In addition, the surface had a blue color appearance.

### Example 7

For warp, a double-ply twisted yarn (A) was obtained in the same manner as in Example 5. In addition, for weft, using a meta-type wholly aromatic polyamide fiber having kneaded therein carbon particles with an average particle size of 0.04 μm in an amount of 1.7 wt % and containing no UV absorber (manufactured by Teijin Limited, “Teijinconex”®, single fiber fineness: 2.2 dtex, fiber length: 51 mm) and a para-type wholly aromatic polyamide fiber (manufactured by Teijin Aramid, “Twaron”®, single fiber fineness: 1.7 dtex, fiber length: 50 mm) , a spun yarn with a cotton count of 40/1 was formed at 23.4 twists/2.54 cm (twist direction: Z) such that the meta-type wholly aromatic polyamide fiber: 65 wt % and the para-type wholly aromatic polyamide fiber: 35 wt %, and then, at 23.4 twists/2.54 cm (twist direction: S), a double-ply twisted yarn (B) was obtained.

Next, using the double-ply twisted yarn (A) as warp and the double-ply twisted yarn (B) as weft, a woven fabric having a warp density of 77 yarns/2.54 cm and a weft density of 52 yarns/2.54 cm was woven by twill weaving (2/1 twill structure).

The obtained undyed woven fabric (gray fabric) was desized, scoured, and dried in the usual manner, and then, using a jet dyeing machine, the fabric was dyed in a dye bath containing a cationic dye (for beige color) and a carrier agent for 60 minutes at a temperature of 130° C. raised from ambient temperature. Subsequently, finish setting was performed.

In the obtained cloth (arc protective woven fabric), the warp density was 79 yarns/2.54 cm, the weft density was 57 yarns/2.54 cm, the carbon particle content was 0.46 wt % based on the cloth weight, the lightness index L-value was 42, and the weight per unit was 180 g/m². The ATPV value was as excellent as 8.8 cal/cm². In addition, the surface had a beige color appearance.

### Example 8

A cloth (arc protective woven fabric) was obtained in the same manner as in Example 5, except for using, for weft, a meta-type wholly aromatic polyamide fiber having kneaded therein carbon particles with an average particle size of 0.5 μm in an amount of 1.1 wt % and containing no UV absorber (manufactured by Teijin Limited, “Teijinconex”®, single fiber fineness: 2.2 dtex, fiber length: 51 mm).

In the obtained cloth (arc protective woven fabric), the warp density was 81 yarns/2.54 cm, the weft density was 57 yarns/2.54 cm, the carbon particle content was 0.43 wt % based on the cloth weight, the lightness index L-value was 44 with a surface having a beige color appearance, and the weight per unit was 184 g/m². The ATPV value was as excellent as 8.4 cal/cm². However, the appearance quality of the cloth was mediocre due to fluff formation and yarn breakage resulting from single-yarn breakage.

### Comparative Example 2

A cloth (arc protective woven fabric) was obtained in the same manner as in Example 5, except for using, for weft, a meta-type wholly aromatic polyamide fiber having kneaded therein carbon particles with an average particle size of 0.08 μm in an amount of 2.0 wt % and containing no UV absorber (manufactured by Teijin Limited, “Teijinconex”®, single fiber fineness: 2.2 dtex, fiber length: 51 mm).

In the obtained cloth (arc protective woven fabric), the warp density was 80 yarns/2.54 cm, the weft density was 57 yarns/2.54 cm, the carbon particle content was 0.79 wt % based on the cloth weight, the lightness index L-value was 23, and the weight per unit was 182 g/m². The ATPV value was as excellent as 8.3 cal/cm². However, the surface had a black appearance due to the carbon particles, resulting in low visibility.

### Comparative Example 3

For warp and weft, using a meta-type wholly aromatic polyamide fiber having kneaded therein carbon particles with an average particle size of 0.08 μm in an amount of 1.1 wt % and containing no UV absorber (manufactured by Teijin Limited, “Teijinconex”®, single fiber fineness: 1.7 dtex, fiber length: 51 mm), a para-type wholly aromatic polyamide fiber (manufactured by Teijin Aramid, “Twaron”®, single fiber fineness: 1.7 dtex, fiber length: 50 mm), and an electrically conductive acrylic fiber as a fiber containing an agent having IR absorption performance and electrical conduction performance (eccentric sheath-core electrically conductive acrylic fiber, single fiber fineness: 3.3 dtex, fiber: 38 mm, sheath: acrylic/core: metal compound), a spun yarn with a cotton count of 40/1 was formed at 23.4 twists/2.54 cm (twist direction: Z) such that the meta-type wholly aromatic polyamide fiber: 93 wt %, the para-type wholly aromatic polyamide fiber: 5 wt %, and the electrically conductive acrylic fiber: 2 wt %, and then, at 23.4 twists/2.54 cm (twist direction: S), a double-ply twisted yarn (A) was obtained.

Next, using the double-ply twisted yarn (A) as both warp and weft, a woven fabric having a warp density of 86 yarns/2.54 cm and a weft density of 60 yarns/2.54 cm was woven by twill weaving (2/1 twill structure).

The obtained gray fabric was desized, scoured, and dried in the usual manner, followed by finish setting.

In the obtained cloth (arc protective woven fabric), the warp density was 86 yarns/2.54 cm, the weft density was 63 yarns/2.54 cm, the carbon black content was 1.0 wt % based on the cloth weight, the lightness index L-value was 19, and the weight per unit was 178 g/m². The ATPV value was as excellent as 8.4 cal/cm². However, the surface had a black appearance, resulting in low visibility.

### INDUSTRIAL APPLICABILITY

According to the invention, a cloth and a protective product, which are excellent not only in flame retardancy but also in protection performance against electric arcs, and can further be provided with any color appearance, are provided, and the industrial value thereof is extremely high.

1. A cloth comprising a flame-retardant fiber,
the cloth being characterized by containing a UV absorber or carbon particles and having a lightness index L-value of 25 or more.

2. The cloth according to claim 1, wherein the flame-retardant fiber is a meta-type wholly aromatic polyamide fiber containing the UV absorber.

3. The cloth according to claim 1, wherein the UV absorber is fixed to the cloth with a binder resin.

4. The cloth according to claim 1, wherein the UV absorber is at least one kind selected from the group consisting of salicylic acid-based compounds, benzophenone-based compounds, benzotriazole-based compounds, benzoxazine-based compounds, bisphenol-based compounds, and metal oxides.

5. The cloth according to claim 1, wherein the content of the UV absorber is within a range of 0.2 to 5.0 wt % based on the cloth weight.

6. The cloth according to claim 1, wherein the average absorption coefficient for incident light at a wavelength of 200 to 400 nm is 90% or more.

7. The cloth according to claim 1, wherein the flame-retardant fiber is a meta-type wholly aromatic polyamide fiber containing the carbon particles.

8. The cloth according to claim 7, wherein the carbon particles have an average particle size of 0.1 μm or less.

9. The cloth according to claim 1, wherein the content of the carbon particles is 0.5 wt % or less based on the cloth weight.

10. The cloth according to claim 1, further comprising a fiber containing an agent having IR absorption performance and/or electrical conduction performance.

11. The cloth according to claim 1, wherein the ATPV value as measured by Arc Resistance Test ASTM F1959-1999 is 8.0 cal/cm² or more.

12. The cloth according to claim 1, wherein the afterglow time as measured by Flammability Test described in ISO 15025: 2000 Procedure B method is 1 second or less.

13. A protective product comprising the cloth according to claim 1 and selected from the group consisting of arc protective garments, flameproof protective garments, work garments, activity garments, hats, gloves, aprons for protection, and members for protection.

14. The cloth according to claim 2, wherein the UV absorber is fixed to the cloth with a binder resin.
